(19) United States
(12) Patent Application Publication
(10) Pub. No.: US 2025/0212872 A1
(43) Pub. Date: Jul. 3, 2025

(54) Compositions and Methods for Protecting Plant Roots and Enhancing Plant Growth

(71) Applicant: Midwestern BioAg Holdings, LLC, Blue Mounds, WI (US)

(72) Inventors: Christopher D. Kniffen, Yankton, SD (US); Gajanthan Balakaneshan, Verona, WI (US)

(21) Appl. No.: 19/086,455

(22) Filed: Mar. 21, 2025

Related U.S. Application Data
(63) Continuation-in-part of application No. 18/369,971, filed on Sep. 19, 2023.
Application No. 18/369,971 is a continuation of application No. 18/193,846, filed on Mar. 31, 2023.
(60) Provisional application No. 63/326,630, filed on Apr. 1, 2022.

(51) Int. Cl. A01N 25/02; A01N 25/22; A01N 43/16; A01N 59/06; A01N 63/10; A01P 21/00; C05D 9/00; C05F 11/00; C05G 1/00

(52) U.S. Cl. CPC A01N 25/02; A01N 25/22; A01N 43/16; A01N 59/06; A01N 63/10; A01P 21/00; C05D 9/00; C05F 11/00; C05G 1/00

(57) ABSTRACT

Compositions and methods related to plant root protection, biological stimulation, and plant biomass enhancement are described. The compositions may comprise a dry blend of a low methoxyl (LM)-pectin powder; calcium and a sugar blend and are characterized by a viscosity, surface tension and saccharide composition comparable to plant mucilage and/or extracellular polymeric substances (EPS).

### RELATED APPLICATIONS

This is a continuation in part of U.S. application Ser. No. 18/193,846, filed Mar. 31, 2003, and claims the benefit of U.S. Provisional Application No. 63/326,630, filed Apr. 1, 2022, which application is incorporated herein by reference in its entirety.

### TECHNICAL FIELD

The subject matter of this disclosure relates to the field of plant root protection, biological stimulation, and plant biomass enhancement with a gelling composition of a uronic acid and a cation, and optionally an organic acid.

### BACKGROUND

Sedimentation of liquid slurries is a common problem when using liquid organic fertilizers. To date, the standard methodology for ameliorating these considerations is the employment of tank agitators which severely constrains the adoption of these organic fertilizer products, practically for those small and underserved communities without the capital for equipment investments. Leaching in the soil is also another primary concern with these products as the residency time in the rhizosphere is critical for efficacy.

In an effort to control the sedimentation of liquid slurries it was discovered that increasing the viscosity of the slurry could effectively decrease sedimentation fallout.

Common in the food industry, increasing the viscosity of a product provides even distribution of flavor and other components thus preventing stratification and sedimentation.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

In some aspects, the invention describes compositions that are a blend of a uronic acid and a polyvalent cation. In some aspects, the uronic acid is a polysaccharide comprising a backbone of repeating D-galacturonic acid monomer units, a sugar and optionally calcium, where the compositions are characterized by gelling of the polysaccharide upon solubilization of the blend in water. In some aspects any of these compositions are applicable as a synthetic root exudate. In some aspects these compositions are formulated as a granular fertilizer.

In some aspects any of these compositions are applicable in methods of protecting plant roots, in a method of stimulating growth of plant roots and increasing plant biomass, in a method of delivering a product to a plant root system, in a method of enhancing residency time of beneficial agents in a plant rhizosphere, in a method of reducing heavy metal toxicity and salinity of plant roots, in a method of controlling the sedimentation rate of a liquid slurry suspension for use as a root stimulant, in a method of coating a seed.

Other methods, features and/or advantages is, or will become, apparent upon examination of the following figures and detailed description. It is intended that all such additional methods, features, and advantages be included within this description and are protected by the accompanying claims.

### DETAILED DESCRIPTION

We now describe in detail compositions and methods related to plant root protection, biological stimulation, and plant biomass enhancement. The compositions and methods also relate to uses as a water storage enhancement, soil stabilizer, erosion control, anionic (Nitrogen and Sulfur) stabilization, amelioration of heavy metal toxicity, and salinity. The compositions and methods also relate to the use of technology as a granulation and tablet binder, dust control agent, sedimentation control of liquid slurry suspensions, and flocculant. Lastly, compositions and methods have demonstrated benefits for animal and human health functioning as a gut prebiotic, binder for cholesterol and bile acids inhibiting reabsorption, accelerated wound healing, and reducing blood glucose levels. Lastly, the compositions and methods present an opportunity to develop a closed loop technology which utilizes co-products derived from the existing food industry, establishing new markets for waste products and opportunities for domestic food security.

During the exploration of various opportunities for increasing the viscosity of a liquid slurry, we have discovered that plant mucilage and extracellular polymeric substances (EPS) excreted from soil microorganisms shared mutual chemical and physical properties, predominantly viscosity, surface tension, and saccharide composition. Mucilage and EPS are responsible for trapping cations, in particular Calcium, which functions to increase the thickness of these biofilms functioning as a root protectant. Upon drying, these biofilms protect the root under drought due to their hydrophobic properties maintaining turgor pressure in the plant preventing hydraulic failure.

Additionally, plant biofilms also ameliorate heavy metal toxicity, salinity, and root oxidation. The biofilms also function as a substrate creating a microaerobic environment for bacterial enhancement and growth. Mucilage and EPS can also act as a nutrient source for the plant. Current rates of mucilage exudation on maize plants have been reported at 1.41 mg dry weight per day and root tip, with a maximum decomposition rate of 50% in 7 days (Nazari et al, 2022).

In some aspects, the invention describes a blend of uronic acid and a polyvalent cation. In some aspects, the invention describes a uronic acid that is a polysaccharide comprising a backbone of repeating D-galacturonic acid monomer units and a sugar. The polysaccharide and sugar blend are characterized by gelling of the polysaccharide upon solubilization of the blend in water and adjusting the temperature, pH, sugar content, or catalyst of the solution to effect gel formation. In some aspects the invention describes a blend of consisting essentially of a polysaccharide and sugar blend. In some aspects, the inventions described a blend consisting of a polysaccharide and sugar blend. In this context, consisting essentially of is intended to mean that the blend comprises polysaccharide and sugar with other trace elements that comprise less than 20% of the composition as a whole and the other elements are not materially significant, are inactive or inert with respect to the function of the blend.

In some aspects, the invention describes a blend of a polysaccharide comprising a backbone of repeating D-galacturonic acid units; calcium; and sugar. The blend is characterized by structure-related gelling of the polysaccharide upon solubilization of the dry blend in water. In some aspects the invention describes a blend of consisting essentially of a polysaccharide, calcium and sugar blend. In some aspects, the inventions described a blend consisting of a polysaccharide, calcium, and sugar blend. In this context, consisting essentially of is intended to mean that the blend comprises polysaccharide, calcium and sugar with other trace elements that comprise less than 20% of the composition as a whole and the other elements are not materially significant, are inactive or inert with respect to the function of the blend.

In some aspects, the invention encompasses a combination of a low methoxyl (LM)-pectin; milk powder or liquid; and sugar. In some aspects the inventions describes a blend of consisting essentially of (LM)-pectin, milk, and sugar blend. In some aspects, the inventions described a blend consisting of (LM)-pectin, milk, and sugar blend. In some aspects, the invention encompasses a low methoxyl (LM)-pectin in an amount, (w/w) of the dry blend of about 18%; milk powder in an amount, (w/w) of the dry blend of about 4%; and sugar in an amount, (w/w) of the dry blend of about 78%. In some aspects, the invention encompasses one pound of the dry blend composition of low methoxyl (LM)-pectin; milk powder or liquid; and sugar with between about two and about four gallons of water. In this context, consisting essentially of is intended to mean that the blend comprises low methoxyl (LM)-pectin; milk powder or liquid; and sugar with other trace elements that comprise less than 20% of the composition as a whole and the other elements are not materially significant, are inactive or inert with respect to the function of the blend.

In some aspects, the polysaccharide, calcium, or sugar of any of these compositions are in a solid or liquid form. Further the blend of uronic acid, polyvalent cation, and optionally a sugar or organic acid may be stored in a liquid or solid form.

In some aspects, the polysaccharide of any of these compositions are a homopolymer or heteropolymer.

In some aspects, the polysaccharide of any of these compositions are heteropolymeric polysaccharide comprises a backbone of repeating D-galacturonic acid monomer units while further comprising at least one of L-Rhamnose, KDO, DHA, D-Galactose, L-Fucose, D-Xylose, D-Glucuronic acid, L-Galactose, L-Arabinopyranose, L-Arabinofuranose, D-Apiose, or L-Acetic acid.

In some aspects, the polysaccharide of any of these compositions are amidated or non-amidated.

In some aspects, the inventive compositions, blends or solutions may optionally comprise sugar as an added component. The sugar of any of these compositions is glucose. In some aspects, the sugar is a blend of glucose, galactose, mannose, gulose, talose, fructose or similar sugars. The term blend of glucose, galactose, mannose, gulose, talose, fructose or other sugars also covers mixtures of glucose and similar sugars, the sugars combined in any combination with respect to type of sugar and total amount of each sugar added to the whole mixture or blend or combined sugar component of the overall blend.

In some aspects, the polyvalent cation is not particularly limited.

In some aspects, the inventive compositions, blends or solutions may comprise an organic acid.

In some aspects any of these compositions are formulated as a kit comprising: a polysaccharide comprising a backbone of repeating D-galacturonic acid units, sugar, and optionally calcium as well as instructions for forming a blend of the polysaccharide, sugar, and optionally calcium and instructions for solubilizing the blend with water.

In some aspects any of these compositions are applicable as a synthetic root exudate. A solution formed from water and any of these compositions forms a synthetic root exudate. The synthetic root exudate being comparable to a plant mucilage and/or extracellular polymeric substances (EPS) in viscosity, surface tension and saccharide composition, and the synthetic root exudates acting a nutrient and water source for the plant.

In some aspects any of these compositions are applicable in a method of protecting plant roots. A solution formed from water and any of these compositions forms a synthetic root exudate. The method including steps of applying the solution to plant roots and drying the plant roots. The solution functions to maintain turgor pressure, provides nutrients and water to the plant roots for a period of time, thereby protecting the plant roots.

In some aspects any of these compositions are applicable in a method of stimulating growth of plant roots and increasing plant biomass. A solution formed from water and any of these compositions and the solution is applied to plant roots. The solution increases the thickness of a protectant surrounding the root, provides a substrate for creating a microaerobic environment for bacterial enhancement and growth, and provides a nutrient source for the plant, all of which thereby stimulate growth of the plant roots and enhancing plant biomass.

In some aspects any of these compositions are applicable in a method of delivering a product to a plant root system. A solution formed from water and any of these compositions also including a product. The solution is applied to plant roots, the solution increases the thickness of a protectant surrounding the root while additionally providing delivery means of the product in solution directly to the plant root. The product may be a nutrient, ameliorating agent, or plant protectant. In some aspects the product is not a plant growth promoting rhizobacteria.

In some aspects any of these compositions are applicable in a method of enhancing residency time of beneficial agents in a plant rhizosphere. A solution formed from water and any of these compositions also including a beneficial agent, and the solution is applied to plant roots where the solution increases the thickness of a protectant surrounding the root and increases residence time of a beneficial agent in and around the plant root and the plant rhizosphere.

In some aspects any of these compositions are applicable in a method of reducing heavy metal toxicity and salinity of plant roots. A solution formed from water and any of these compositions and the solution is applied to plant roots, where the solution serves as an ameliorant of heavy metal toxicity and salinity.

In some aspects, any of these compositions are applicable in a method of controlling the sedimentation rate of a liquid slurry suspension for use as a root stimulant. A solution formed from water and any of these compositions and the solution and the solution is applied to plant roots, where a structure-related gelling of the polysaccharide in solution decreases the sedimentation rate of any non-soluble sediments or products within the solution when compared to a solution lacking the polysaccharide.

In some aspects any of these compositions are applicable in a method of coating a seed. A solution formed from water and any of these compositions and the solution is applied to a seed, and after drying the seed, a coated seed is formed. In some aspects, the invention also includes a coated seed, the coated seed including a seed and a coating surrounding the seed, the coating comprising any of the compositions.

In some aspects any of these compositions are applicable as a granular fertilizer including a polysaccharide comprising a backbone of repeating D-galacturonic acid monomer units, a sugar, and optionally calcium or calcium product blended uniformly together and provided in a granular form for application as a fertilizer.

### I. Definitions

Unless otherwise defined, all technical and scientific terms used herein have the same meaning as commonly understood by one of ordinary skill in the art to which this invention pertains. In case of conflict, the present specification, including definitions, will control.

Unless otherwise specified, “a,” “an,” “the,” “one or more of,” and “at least one” are used interchangeably. The singular forms “a”, “an,” and “the” are inclusive of their plural forms.

The recitations of numerical ranges by endpoints include all numbers subsumed within that range (e.g., 0.5 to 5 includes 1, 1.5, 2, 2.75, 3, 3.80, 4, 5, etc.).

The term “about,” when referring to a value or to an amount of mass, weight, time, volume, concentration, or percentage is meant to encompass variations of +1.5 wt % from the specified amount. The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. The phrase “selected from the group consisting of” is meant to include mixtures of the listed group, but only in trace amounts and only added components that can be considered inert or inactive.

Any component referred to in an amount defined by a %, wt %, wt %, or % by weight is intended to encompass a weight percent relative to the whole composition or blend being defined as 100%, 100 wt % or 100% by weight.

Moreover, the present disclosure also contemplates that in some aspects, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

### II. Polysaccharide

According to some aspects of the invention, any polysaccharide that has a characteristic of forming a structure-related gel in solution forms the foundation for the compositions and methods described herein. The terminology “structure-related gel formation” describes the formation of a viscous gel upon solubilization of the polysaccharide in solution.

### Uronic Acid

It is appreciated however that any uronic acid, defined as a type of sugar molecule where the primary alcohol group at the end of the sugar chain has been oxidized to a carboxylic acid group, essentially creating a sugar with acidic properties; it's formed from the oxidation of a sugar's terminal hydroxyl group, and the name of each uronic acid is usually derived from the parent sugar it came from (e.g., glucuronic acid comes from glucose). Thus, the term uronic acid can refer to any homopolymer composed of repeating unites of a singly type of sugar molecule meeting the aforementioned definition. However, it is also appreciated that a polymer of repeating uronic acids monomers may in fact encompass both a homopolymer or heteropolymer. A heteropolymer may be composed of both glucuronic and galacturonic monomers as a polymer. It is also appreciated the polymer of a uronic acid may be modified and yet still retain the essential characteristic of a uronic acid polymer forming a gelling solution.

### Pectins

In some aspect, the polysaccharide according to aspects of the invention is a pectin. Pectin is well known in the food industry to function as a thickening agent particularly for its gelling properties.

Generally, a pectin comprises a backbone of repeating D-galacturonic acid units or monomers. Also applicable to some aspect of the invention is any homopolymer or heteropolymer of repeating uronic acid units. This backbone may comprise solely repeating D-galacturonic acid units. In some aspects, the backbone comprises D-galacturonic acid units repeating at regular intervals, for example every other unit. The pectin structure may be branched or linear. The pectin structure may comprise a homopolymer of D-galacturonic acid units. Alternatively, the pectin may comprise a heteropolymeric structure that, in addition to a backbone of repeating D-galacturonic acid units or monomers, additionally comprises branches comprising units other than D-galacturonic. That is, a pectin may comprise D-galacturonic acid, L-rhamnose, KDO, DHA, D-galactose, L-fucose, D-xylose, D-glucuronic acid, L-galactose, L-arabinopyranose, L-arabinofuranose, D-apiose, or L-aceric acid in any combination. For example, a pectin according to some aspects of the invention describe as an arabinogalactan I or II, a rhamnogalacturonan I or II.

Pectins belong to family of polysaccharides and can by either synthetic or plant derived. A pectin source may be an apple pomace, a black currant, a black mulberry pomace, cacao pod husks carrot, gold kiwifruit pomace, mango peel, okra, orange peel, peach, pistachio, plum, pomegranate, raspberry, soy, strawberry, sugar beet pulp, sunflower, yellow passion fruit peel.

Pectins share similar physical and chemical properties as plant mucilage and EPS and thus present a unique opportunity to act function as thickening agent, nutritional source for the plant, substrate for soil microbiological enhancement, ameliorating agent, plant protectant, and other manufacturing opportunities.

Upon activation, Pectin forms what is referred to as an “egg-carton technology” which links the polysaccharide chains forming a gel. This “egg-carton technology” alters the structural and physical properties of water creating a substrate they can hold water suspendable substances in suspension. While use of calcium, calcium salt, or calcium containing product such as a milk are described as useful for forming this egg-carton type gelling structure, it is fully appreciated and encompassed by the invention that any polyvalent cation could achieve the same effect.

Pectins, and uronic acid polymers generally are classified based on their degree of esterification. Any uronic acid with a degree of esterification, the esterification in the range of between about 10% to about 50% is envisioned as usable in the compositions, blends and solutions of the invention. High methoxyl (HM) pectin require heat and the pectin is activated by glucose and low methoxyl (LM)-pectin. HM pectin is commonly used in the food industry for jellies and jams, while LM pectin is utilized for similar low-sugar food products.

Low methoxyl pectin is differentiated from HM pectin in that it does not require heat or glucose to activate, LM pectin will activate in the presence of calcium, as calcium forms the cross-linking bridges binding the pectin polysaccharides and thus creating the “egg-carton technology”.

LM pectin also presents additional opportunities and advantages over its HM counterpart for agricultural purposes. It was discovered during initial testing, that LM pectin does not require heat to activate and can activate across a wide range of pH's.

Pectin based products present a unique opportunity, not only for plant and soil health benefits, but also as a novel granulation binder. The “egg-carton” technology of pectin and the hydrophobic properties once dried, present desired interest in the use of this technology as a binding agent, granulation stabilizer, and dust suppressant. LM pectin also present additionality as an organic flocculant or thickening agent based on the material loaded into the “egg-carton” technology and the desired syneresis.

The pectin based products available for use in aspects of this invention may be obtain from any source and processed or prepared by any means.

The pectin based products available for use in aspects of this invention may be amidated or non-amidated. In some aspects the amount of amidation of the pectin may include the rate or extend for polysaccharide gel formation in solution. Further the amount of amidation of the pectin may influence the amount of calcium required to form the “egg-carton” formation of the pectin.

The use of non-amidated LM pectin, derived from plant pomace (apple), is an approved organic amendment. Allowing for the patent to be suitable for organic and non-organic production systems if the ingredients are sourced appropriately and certified through the appropriate organic agencies.

The phrase pectin may also be known by the synonyms BETA-D-GALACTOPYRANURONIC ACID; 18968-14-4; beta-D-galacturonic acid; (2S,3R,4S,5R,6R)-3,4,5,6-tetrahydroxyoxane-2-carboxylic acid; 55NG3O9NDD; oligogalacturonide; UNII-55NG3O9NDD; SCHEMBL3407163; CHEBI: 47954; Galactopyranuronic acid, beta-D-; ZINC4097542; DB03652; C08348; WURCS=2.0/1,1,0/[a2112A-1b_1-5]/1/; (2S,3R,4S,5R,6R)-3,4,5,6-Tetrahydroxytetrahydro-2H-pyran-2-carboxylic acid; and (2S,3R,4S,5R,6R)-3,4,5,6-Tetrahydroxytetrahydro-2H-pyran-2-carboxylicacid

### III. Structure-Related Gelling of the Polysaccharide

In some aspects, a “catalyst” may be necessary to commence or enhance formation of the structure-related gelling of the polysaccharide. Commencing or enhancing the formation of structure-related gelling of the polysaccharide may occur with a changes in temperature or pH of solution. For some LM-pectins, addition of calcium ion to the solution may commence or enhance the formation of structure-related gelling of the pectin. The source of calcium may be in the form of an ionic calcium powder, a liquid calcium concentrate, or a substance know to have high amounts of calcium such as milk in powdered or liquid form.

### IV Sugar

In some aspects, the solution of polysaccharide and “catalyst” may also be accompanied by a sugar. The sugar prevents pre-gelling and syneresis (clumping) during solubilization of the polysaccharide. The sugar by be in solid or liquid form. The sugar may be glucose. In some aspects, the sugar is a blend of different sugars, including for example a blend of glucose, galactose, mannose, gulose, talose, fructose or similar sugars. Similar sugars being any sugar or other structure that is useful in plant nutrition or enhancing solubilization of the polysaccharide.

In some aspects a blend containing up to 80% sugar is added to pectin and calcium in order to prevent pre-gelling or clumping of the blend. Upon forming a solution, sugar is present in an amount of between about 10% and 30%, or about 20%. It has additionally been found that other additives may be substituted, and that sugar is optional in the formation of a blend according to some aspects of the invention.

### V. Cation

In some aspects, the solution further comprises a source of cation. In some aspects the cation is Calcium. In some aspects, the source of Calcium is a milk product, though any source of Calcium ion in any form, such as a salt are applicable to the solutions described herein. The cation may also be a Potassium or Magnesium or another cation. Further in some aspects, the cation may be any combination of Calcium, Potassium or Magnesium. In some aspects, the cation may be a combination of Calcium with any other cation. The cation may be a polyvalent cation. The polyvalent cation is not particularly limited. The polyvalent cation may be a divalent cation. The cation may be a calcium, potassium, magnesium, sodium, copper, iron, mercury, cobalt, barium silver, nickel, zinc, cobalt, chromium, tin, gold, aluminum, lithium, rubidium, cesium, or any combination thereof. In general, the amount of polyvalent cation in the final solution (once the blend is diluted in water to form a solution) that is applied to plant roots comprises 10-4500 mg of polyvalent cation.

### VI Additives

In some aspects, the inventive compositions, blends or solutions may comprise an organic acid. Briefly, organic acid may be defined as an organic compound with acidic properties. The most common organic acids are the carboxylic acids, whose acidity is associated with their carboxyl group-COOH. Sulfonic acids, containing the group-SO2OH, are relatively stronger acids. Alcohols, with-OH, can act as acids but they are usually very weak. The relative stability of the conjugate base of the acid determines its acidity. Other groups can also confer acidity, usually weakly: the thiol group —SH, the enol group, and the phenol group. In biological systems, organic compounds containing these groups are generally referred to as organic acids.

In some aspects, any other plant beneficial additive is added to a formulation comprising a pectin, a sugar and a cation. The additive may include for example, any ingredient typically found in a fertilizer or beneficial to bare plant roots or seeds for optimal maintenance and growth of the root or seed. The additive may include for example nitrogen, ammonia, urea, phosphates, potassium, manganese, boron, iron, chlorine, copper, molybdenum, minerals, herbicides, fungicides, pesticides, macro nutrients, micronutrients, vitamins, essential nutrients, vanadium, sulfur, magnesium, zinc, potash, EDTA, surfactants, saponifiers, or pH modifiers. In some aspects the additive is a chelator, a frost inhibitor, a UV inhibitor, a salinity ameliorating agent, a soil stabilizer, a rooting agent, a humectant, a binder, an organic herbicide, a preemergent, a dispersant, an organic acid.

### EXAMPLES

For the purposes of promoting an understanding of the principles of the present disclosure, reference will now be made to preferred aspects and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

### Example 1: Formation of a Pectin, Calcium, Sugar Dry Blend

We successfully dry blended, LM pectin, glucose (sugar), and calcium (dry milk) prior to solubilization and activation which yielded a dry blended product with shelf-life storability, improved handling, and reduced shipping costs over the HM pectin and other glucose counterparts.

The dry sugar (glucose) component to this dry blend, was for the purpose of preventing pre-gelling of the LM pectin during solubilization. The glucose also functions to diversify the saccharoidal composition the final product.

Initial Dry blend formulation:
1. LM Pectin-18.1%
2. Dry Milk-3.8%
3. Sugar-78.1%

One pound of dry blend solubilized, yields 2-4 gallons of product, depending upon desired viscosity. 25 mg of Calcium is required to activate 1 g of low methoxyl pectin. The sugar target is 20% of the final liquid volume. The sugar prevents pre-gelling and syneresis (clumping) during solubilization, as such it is an important constituent of the final blend. Solubilization of the dry blend is enhanced with the use of a mixing cone and inductor system.

### Example 2: Applications of Dry Blend

The pectin, dry milk, and sugar dry blend of Example 1 is used as liquid bio stimulant fertilizer to be applied in furrow at planting. Prior to application, the user will solubilize the dry blend with water to the desired viscosity. Once solubilized the liquid can be applied through a liquid planter applicator. Once applied the solubilized dry blend will protect the emerging roots increasing water availability and nutrients to the newly germinated seed. Plant vigor will be enhanced, and root biomass will continue to increase.

The blend of Example is also used as a microbial substrate (biostimulant), a water storage enhancer; a soil aggregate stabilizer; a plant root stimulant; a plant root protectant; a salinity amelioration agent; a nutritional seed coating; a dust control agent; a fertilizer coating; a biofilm for pesticides (sticking agent); a fertilizer enhancer; a nitrogen stabilizer; a anti-leaching agent; a granulation binder; or a soil additive.

The blend of Example 1, once reconstituted in water as appropriate may be used as a spray on foliant.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

### Example 3: Formation and Use of a Pectin, Calcium Blend

In some cases, a blend of pectin and calcium in the presence of an additive such as a carboxylic acid ester or other organic acid. The blend is either a solid or liquid and is composed of:
1. Uronic acid (for example LM Pectin)-1 g to 50 g
2. Polyvalent cation-1 mg to 100 mg.
   The blend is such that the uronic acid has a degree of esterification from about 10% to about 50%. For such a blend, gel activation occurs at approximately 14 mg to about 70 mg polyvalent cation to 1 g LM Pectin or other uronic acid. The blend can further be described by keeping the polyvalent cation consistent at 25 mg of polyvalent cation for uronic acid in a range of about 7 g to about 35 g uronic acid.

Since the blend is stable in both solid and liquid forms, the blend is easily transported to a site for use. The Site may be any field, turf, ornamental site where plant growth is desired. The site may be a commercial agricultural site or a personal home lawn or garden. The blend is then diluted with water and added to vegetation, or seedlings, or seeds at the site.

1. A method of stimulating growth of plant roots and increasing plant biomass, the method comprising:
providing a uronic acid polymer having a backbone of repeating uronic acid units, polyvalent cation and organic acid to form a blend;
solubilizing the blend in water to form a final solution;
applying the solution to plant roots
wherein the solution gels to increase the thickness of a protectant surrounding the root of the plant.

2. The method of claim 1, wherein the uronic acid is polysaccharide having a backbone of repeating D-galacturonic acid units.

3. The method of claim 1, wherein the polyvalent cation is calcium in the form of milk powder, or milk liquid.

4. The method of claim 1, wherein the blend is in a solid or liquid form.

5. The method of claim 1, further comprising an organic acid.

6. The method of claim 5, wherein the organic acid is a carboxylic acid ester.

7. The method of claim 1, wherein the polysaccharide of the blend is a homopolymer or heteropolymer.

8. The method of claim 1 wherein the degree of esterification of the uronic acid is between 10% and 50%.

9. The method of claim 1, wherein the amount of polyvalent cation in the final solution that is applied to plant roots comprises 10-4500 mg of polyvalent cation.

10. The method of claim 1, wherein the composition comprises between about 14 mg to about 70 mg of polyvalent cation for each gram of uronic acid polymer.

11. The method of claim 1, wherein the composition comprises between 7 g-35 g of uronic acid polymer per 25 mg of polyvalent cation.

12. The method of claim 1, wherein the blend further comprises a nutrient, ameliorating agent, or plant protectant agent.

13. The method of claim 28, wherein the ameliorating agent or plant protection agent is an organic herbicide or a preemergent.

14. A blend comprising:
a polysaccharide having a backbone of repeating D-galacturonic acid units, and
a polyvalent cation to form a blend;
wherein, in use, the blend is solubilized in water to form a final solution characterized by gelling of the final solution.

15. The blend of claim 14, wherein the blend is in a solid or liquid form.

16. The blend of claim 14, further comprising an organic acid.

17. The blend of claim 14, wherein the polysaccharide of the blend is a homopolymer or heteropolymer.

18. The blend of claim 14, wherein the degree of esterification of the uronic acid is between 10% and 50%.

19. The blend of claim 14, wherein the blend comprises between 7 g-35 g of uronic acid polymer per 25 mg of polyvalent cation.

20. The blend of claim 14, wherein the blend comprises between about 14 mg to about 70 mg of polyvalent cation for each gram of uronic acid polymer.
